(19) United States
(12) Patent Application Publication
(10) Pub. No.: US 2015/0250238 A1
(43) Pub. Date: Sep. 10, 2015

(54) SUIT TO TUXEDO CONVERTER AND METHOD

(71) Applicant: SEBASTIAN GARCIA, Miami, FL (US)

(72) Inventor: SEBASTIAN GARCIA, Miami, FL (US)

(21) Appl. No.: 14/198,943

(22) Filed: Mar. 6, 2014

(51) Int. Cl. A41D 15/00; A41D 27/08; G06Q 30/06; A41D 1/02

(52) U.S. Cl. CPC A41D 15/00; A41D 1/02; A41D 27/08; G06Q 30/0621

(57) ABSTRACT

A tuxedo converter that includes at least one lapel-cover and further includes a front face and a back face operable to demountably dispose around a lapel body using a fixative. The tuxedo converter also includes at least one button converter. In accordance with the present invention, it also includes a method to convert a suit jacket into a tuxedo look-alike jacket; the method includes the step of using at least one lapel-cover operable to demountably dispose around a lapel body using a fixative. As an alternative, the method may further include the step of using at least one button-converter operable to demountably dispose around a button using an elastic band.

### FIELD OF THE INVENTION

The present invention relates to the art of clothing and the conversion into another type of clothing.

### STATEMENT REGARDING FEDERALLY-SPONSORED RESEARCH AND DEVELOPMENT

None.

### BACKGROUND OF THE INVENTION

In clothing, a suit is a set of attire made from the same cloth, consisting of at least a jacket and trousers. Lounge suits are the most common style of western suits, originating in the United Kingdom. Other types of suits are the dinner suit, part of black tie, which arose as a lounging alternative to dress coats in much the same way as the day lounge suit came to replace frock coats and morning coats; and, rarely worn today, the morning suit.

The word suit is derived from French suite meaning following and from some Late Latin derivative form of the Latin verb “sequor” which means “I follow” since garments making up the suit, like jacket, trousers and waistcoat, follow each other and are made from same cloth material.

In the late 1920s and 1930s, a design considered very stylish was the single-breasted peaked lapel jacket. This has gone in and out of style periodically, most popular during the 1970s. In the 1980s, double-breasted suits with notched lapels were popular with power suits.

Today, suits are available in many variations based on design, cut, cloth like a two and three piece, or single and double-breasted etc. Traditionally they are worn with a collared shirt and necktie. A two-piece suit has a jacket and trousers while a three piece would have a waistcoat in addition. A tuxedo consists of the following components; a jacket made of silk (but not necessarily) and contains satin or silk facings on the peak lapels, trousers have silk braids which matched with the lapels, cummerbund or low cut waist coat in black, pleated front white dress shirt, a bow tie in black, dress sock in formal black, shoes in patented polished leather and black in color.

Suits have self-faced lapels which are collars that match the material of the suit. The lapel has an indentation very similar to notched lapel of tuxedo. There can be two to four buttons on a suit jacket. Most formal suits are in black, dark gray, navy blue or brown, and some can have pinstripes. The trousers (pants) may or may not have cuffs. Some suits come with matching vest. Mostly a tie is worn with the suit though a bow tie can also be opted for.

The only real difference between a tux and a suit is the satin or silk lapel with matching satin stripe on trouser. This small but noticeable difference, makes a tux different from a suit. The lapels are styled in three different ways, notched, shawl and peak. While the notched lapel has a “v” indentation and peak lapel has upward shaped “v” indentation the shawl lapel has none and is usually curved, but none less, both suits and tuxedo jackets have lapels.

A problem is that the cost of traditionally tuxedo jackets is too much for people of non-sophisticated social life that only use the tux on the occasional wedding or formal party. At the same time, most people have suits and suit jackets available to use but is forced to rent or buy an expensive tuxedo jacket to be usually worn only on a single occasion.

Tuxedos are always used during of proms at the end of high school. The reality is that nowadays most high scholars will not be using the tux worn at their prom for the rest of their lives. In contrast, since they are about to go to the workforce, most of them will buy suits for their job interviews. Therefore, there is the need for a fast and inexpensive way to turn a regular suit into a tuxedo.

### SUMMARY OF THE INVENTION

The invention provides a suit to tuxedo converter and method that overcomes the hereinabove-mentioned disadvantages of the heretofore-known suits and tuxedos of this general type.

With the foregoing and other objects in view, there is provided, in accordance with the invention, a tuxedo converter, including at least one lapel-cover, the lapel-cover further comprising: a front face and a back face operable to demountably dispose around a lapel body. The tuxedo converter of may further include at least one button converter.

In accordance with another feature, an embodiment of the present invention includes at least one lapel-cover further includes at least one fold line operable to couple a lapel fold line and may further include at least one fold flap. The lapel-cover may further include an interior fold-line, an exterior fold-line, a gorge line and a folding point

In accordance with a further feature of the present invention, the at least one fixative is attached to the back face of the at least one lapel-cover allowing it to be is interchangeable.

In accordance with a further feature of the present invention, include a fixative, a fixative that could be chemical, mechanical and any combination of both, wherein the fixative is attached to the back face of the at least one lapel-cover.

In accordance with the present invention, a method to convert as suit jacket into a tuxedo look-alike, the method including the step of: using at least one lapel-cover operable to demountably dispose around a lapel body using a fixative. As an alternative, the method may further include the step of using at least one button-converter operable to demountably dispose around a button using an elastic band.

In accordance with another feature, an embodiment of the present invention includes at least one lapel-cover further comprises a interior fold-line, a exterior fold-line, a gorge line, and a folding point wherein the at least one lapel-cover is interchangeable.

In accordance with the present invention, a method for marketing business using a personalized tuxedo converter kit comprising the steps of: 1) uploading a logos using a computer to a website on the world wide web; 2) choosing a color and type of fabric for the personalized tuxedo converter kit; choosing a quantity; 3) paying for the personalized tuxedo converter kit; 4) manufacturing the personalized tuxedo converter kit, the personalized tuxedo converter kit that includes: at least one lapel-cover operable to demountably dispose around a lapel body using a fixative; and 5) at least one button-converter operable to demountably dispose around a button using an elastic band; and delivering the personalized tuxedo converter kit via mail.

In accordance with another feature, an embodiment of the present invention also includes a personalized tuxedo converter kit including at least one lapel-cover further comprises at least one fold line operable to couple a lapel fold line and at least one fixative is attached to the back face of the at least one lapel-cover.

The present invention depicts an inventive solution to the fore mentioned issues related to how to turn a suit jacket into a tuxedo.

Although the invention is illustrated and described as embodied in a Suit to Tuxedo Converter and Method, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure.

Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described, or referenced herein, are well understood and commonly employed using conventional methodology by those skilled in the art.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

As used herein, the term “demountably disposed” refers to the placement of two faces wherein the two faces can be removed and placed back together with little effort many times. As a matter of example and in no means to be used as a limit to the words “demountably disposed” comprises the use of; double sided tape, adhesives, magnetics, buttons, snap buttons, zippers, VELCRO or any combination thereof.

### BRIEF DESCRIPTION OF THE SEVERAL VIEWS OF THE DRAWINGS

The foregoing summary, as well as the following detailed description of the invention, will be better understood when read in conjunction with the appended drawings. For illustrating the invention, the figures are shown in the embodiments that are presently preferred. It should be understood, however, that the invention is not limited to the precise arrangements and instrumentalities shown. In the drawings:

FIG. 1 is frontal graphical view showing the tuxedo converter as used on a suit jacket;

FIG. 2A is frontal graphical view showing a suit jacket with the notched lapel;

FIG. 2B is frontal graphical view showing a suit or tuxedo jacket with the peaked lapel;

FIG. 2C is frontal graphical view showing a suit or tuxedo jacket with the shawl lapel;

FIG. 3 is frontal graphical view showing a suit jacket with a notched lapel without the tuxedo converter;

FIG. 4 is frontal graphical view showing a suit jacket with the tuxedo converter disposed on the suit jacket and buttons;

FIG. 5 is frontal graphical view showing a suit jacket with the tuxedo converter disposed on the suit jacket and buttons;

FIG. 6 is first drawing in a sequence of four drawings showing a frontal graphical view of a converter laminate cover adapted to a notched lapel suit jacket;

FIG. 7 is second drawing in a sequence of four drawings showing a frontal graphical view of a converter laminate as it is turned to its back face;

FIG. 8 is third drawing in a sequence of four drawings showing a frontal graphical view of a converter laminate on its back face depicting the fold lines.

FIG. 9 is fourth drawing in a sequence of four drawings showing a frontal graphical view of a converter laminate on its front face depicting the fold lines;

FIG. 10A is frontal graphical view showing the first step, in a sequence of four steps, in the process of converting a regular suit jacket a tuxedo look-alike using a laminate cover;

FIG. 10B is frontal graphical view showing the second step, in a sequence of four steps, in the process of converting a regular suit jacket a tuxedo look-alike using a laminate cover;

FIG. 10B is frontal graphical view showing the second step, in a sequence of four steps, in the process of converting a regular suit jacket a tuxedo look-alike using a laminate cover;

FIG. 10C is frontal graphical view showing the third step, in a sequence of four steps, in the process of converting a regular suit jacket a tuxedo look-alike using a laminate cover;

FIG. 10D is frontal graphical view showing the final step, in a sequence of four steps, in the process of converting a regular suit jacket a tuxedo look-alike using a laminate cover;

FIG. 11 is frontal graphical view showing a laminate cover as it is placed over a suit's lapel;

FIG. 12 is frontal graphical view showing a pair laminate covers with stitched markings placed over a suit jacket;

FIG. 13, is frontal graphical view showing how the fixative placed over a laminate cover.

FIG. 14, is frontal detail graphical view of how the fixative temporarily attached on the inside of the suit's inner side;

FIG. 15 is frontal detail graphical view of how the fixative temporarily attached on the inside of the suit's lapel.

FIG. 16 a cross-sectional graphical view of a laminate cover embodies disposed around the lapel body attached using a fixative.

FIG. 16A a close-up graphical view of FIG. 16, showing a laminate cover disposed around the lapel body attached using a fixative.

FIG. 17 a cross-sectional graphical view of a laminate cover disposed around the lapel body attached using another type of fixative.

FIG. 17A a close-up graphical view of FIG. 17, showing a laminate cover disposed around the lapel body attached using a fixative.

FIG. 18 a cross-sectional graphical view of a laminate cover embodies one lapel disposed around the lapel body attached using a two-part fixative.

FIG. 18A a close-up graphical view of FIG. 18, showing a laminate cover disposed around the lapel body attached using a two-part fixative.

FIG. 19 a cross-sectional graphical view of a laminate cover embodies one lapel disposed around the lapel body attached using a mechanical fixative.

FIG. 19A a close-up graphical view of FIG. 19, showing a laminate cover disposed around the lapel body attached using a mechanical fixative.

FIG. 20 a cross-sectional graphical view of a laminate cover embodies one lapel disposed around the lapel body attached using another mechanical fixative;

FIG. 20A a close-up graphical view of FIG. 20, showing a laminate cover disposed around the lapel body attached using another mechanical fixative;

FIG. 21 is frontal graphical view showing the tuxedo converter as used on a suit jacket;

FIG. 21A is orthographical view showing a close-up of FIG. 21 showing the button-converter as it is placed of a suit's button;

FIG. 21B is orthographical view showing a close-up of FIG. 21 showing the back face of the button-converter depicting an elastic band;

FIG. 21C is orthographical view showing a close-up of FIG. 21 showing the front of the button-converter depicting the front face;

FIG. 22 is frontal graphical view showing the tuxedo converter as used on a suit jacket for advertising purposes;

FIG. 22A is orthographical view showing a close-up of FIG. 22 showing the button-converter as it is placed of a suit's button for advertising purposes;

FIG. 23 is frontal graphical view showing the tuxedo converter as used on a suit jacket for advertising purposes; and

FIG. 23A is orthographical view showing a close-up of FIG. 23 showing the button-converter as it is placed of a suit's button for advertising purposes;

### DESCRIPTION OF THE INVENTION

While the specification concludes with claims defining the features of the invention regarded as novel, it is believed that the invention will be better understood with the following description with the drawing figures, in which like reference numerals are carried forward. The disclosed embodiments are merely exemplary of the invention, which can be embodied in various forms.

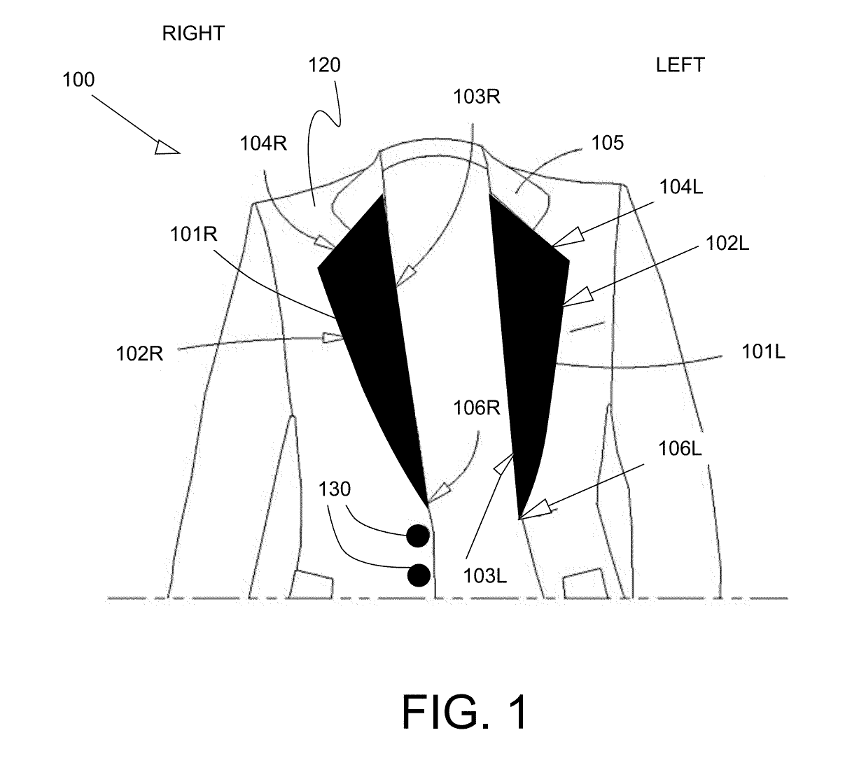

The present invention provides a novel and efficient way to make regular suit look like a tuxedo. Referring now to FIG. 1, a graphical frontal view of one embodiment of the tuxedo converter 100. FIG. 1 shows several advantageous features of the tuxedo converter 100, but, the invention can be provided in several shapes, sizes, combinations of features and components, and varying numbers and functions of the components. Embodiments of the invention provide the tuxedo converter 100 to include: a set of lapel-covers, namely, a left lapel-cover 101L a right lapel-cover 101R, and a plurality of button-converters 130. The invention introduces a novel method to transform a regular suit into a fancy tuxedo look-alike effortlessly.

The first example in how the tuxedo converter 100 works, as shown in FIG. 1, a regular suit jacket 120, that has been converted into a tuxedo look-alike by temporarily fixing to the suits own lapels a set of lapel-covers 101L and 101R, and the suit's buttons, button-converters 130.

Here, in FIG. 1, the left lapel-cover 101L is defined by the following edges: a left interior fold-line 103L, a left exterior fold-line 102L, left gorge line 104L and a left folding point 106L. Similarly, the right lapel-cover 101R is defined by the following edges: a right interior fold-line 103R, a right exterior fold-line 102R, right gorge line 104R and a right folding point 106R. It is envisioned in other embodiments that the left and right lapel-covers 101L-R may extent over the suit's top collar 105 in a similar way.

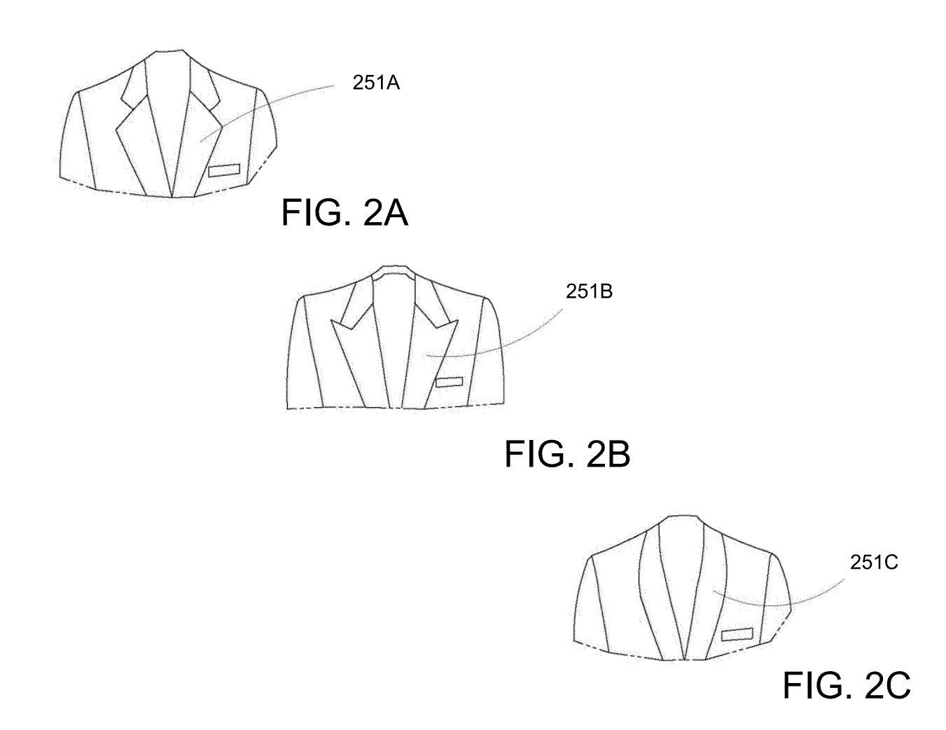

Referring now to FIGS. 2A-C, are frontal graphical views of busts having different types of suit jackets. Here, FIG. 2A depicts the most common of all the suit tops, the notched lapel 251A, (also called “stepped” lapel). Notched lapels are found on single-breasted jackets and are the most informal style. FIG. 2B depicts another common suit/tuxedo top the more classic peaked lapel 251B (also called “pointed”). Double-breasted jackets usually have peaked lapels. Similarly FIG. 2C, another suit/tuxedo top is the shawl lapel 151 C (also called “trick” or Mandarin). Shawl lapels are a style derived from the Victorian informal evening wear, and as such are not normally seen on suit jackets except for dinner suits. It is envisioned that the tuxedo converter 100, shown in FIG. 1, can be adjusted, used and would work with all of the afore mentioned lapels shown in FIGS. 2A-2C.

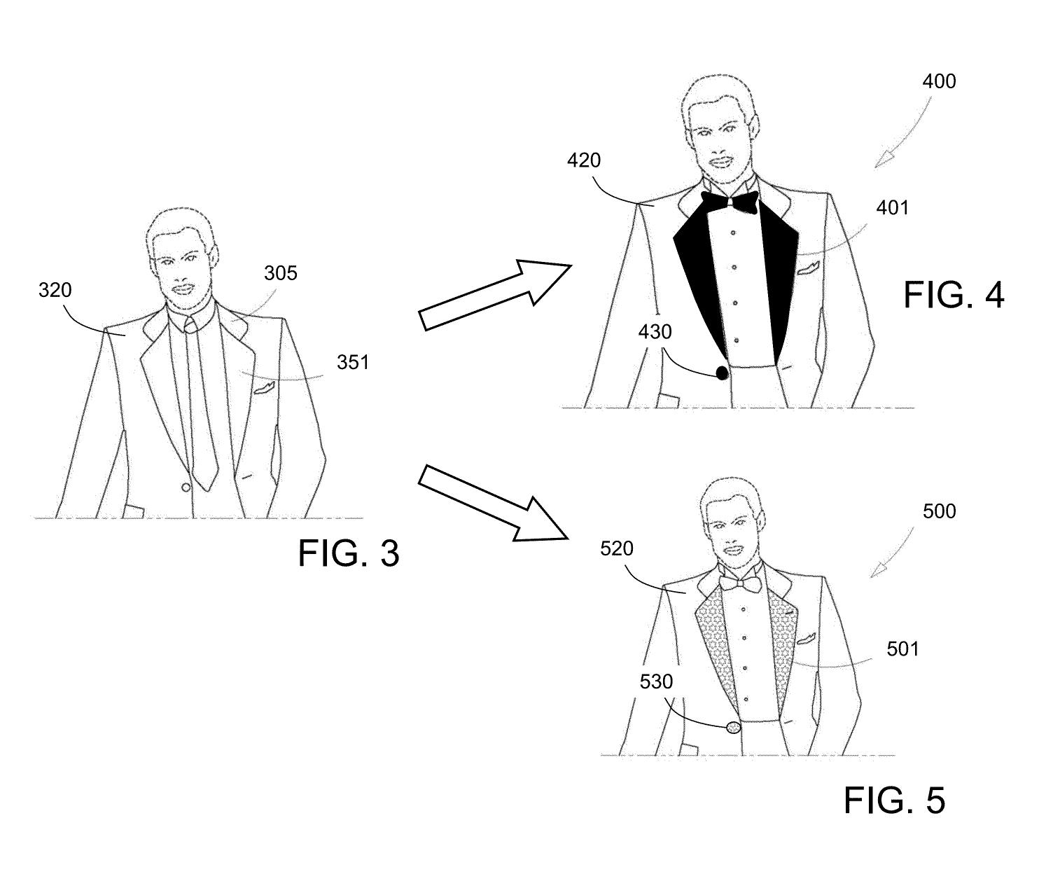

FIG. 3-5 are graphical frontal views of a regular suit jacket 320, and two look-alike tuxedos 420 and 520. FIG. 3 shows a regular suit jacket 320, a notched lapel 351, with a top collar 302. Using the tuxedo converter 400 this inexpensive suit jacket 320 will be transformed into an expensive looking tuxedo 420 as seen in FIG. 4. Similarly, in FIG. 5, using the tuxedo converter 500, with a different design pattern, the inexpensive suit jacket 320 will be converted into and expensive tuxedo 520 look-alike. Since the lapel-covers 401 and 501 and button converters 430 and 530 can be used interchangeably, many tuxedo “looks” can be achieved. Usually tuxedo jackets can go into the hundreds of dollars, but by using the lapel-covers 401 and 501, and button converters 430 and 530, a regular suit jacket 320 is changed into many tuxedo jackets very inexpensively.

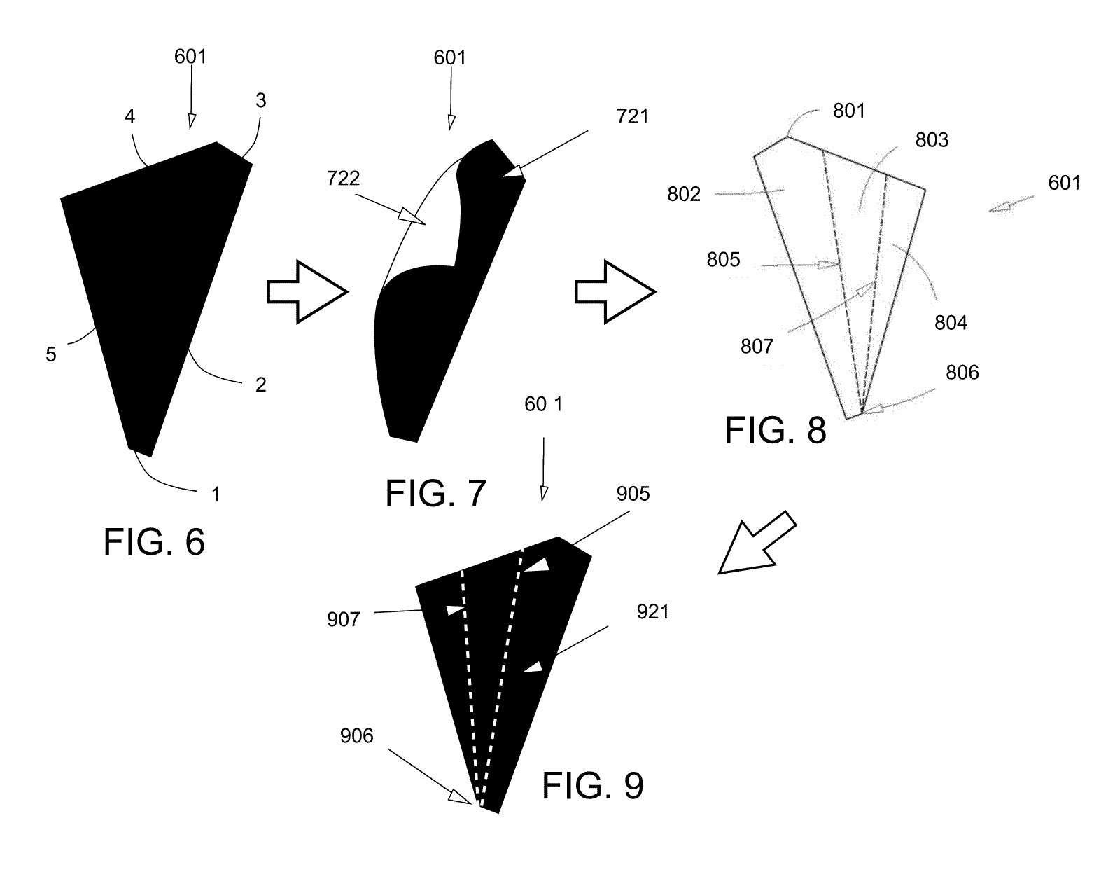

FIGS. 6-9 are to be viewed together, and are a series of graphical frontal views showing the details of a single lapel-cover 601. FIG. 6 shows at least one shape of lapel-cover 601, wherein reference numbers 1-5 represent it's sides. Similar to a scalene triangle, wherein all sides are unequal in dimension, here, side 1 is placed at the bottom of a suit's lapel and side 3 is placed at the top. It is intended for the lapel-cover 601 contour itself around a suit's lapel, hence envisioned that the shape and dimensions of the lapel-cover 601 might vary according to the different suits shown previously in FIGS. 2A-2C, and more.

As we turn the lapel-cover 601 of FIG. 6 on to the other side, now in FIG. 7, it can be shown that the lapel-cover 601 further includes a front face 721 and a back face 722. On the front face 721, the dress cloth is shown, the dress cloth is made of patterns or prints to match the look of a tuxedo. Other patterns envisioned are logos, printed art, text, trade-names, trademarks and more. The ingenious nature of the front face 721 makes so that any type of cloth can be used on this front face 721 allowing the tuxedo lookalike to be used in many occasions, every time showing a different look. Usually front face 721 is made out of silk or silk like materials. Many color silks are available and these would match the handkerchief or any other accessories to the tuxedo.

FIG. 7 also shows the back face 722, here, at least one fixative is used to demountably place the back face 722 around a lapel body. It is intended that the back face 722 be placed on the inside of the lapel body (not shown). By placing the lapel-cover 601 over at least one lapel such as 351, shown previously in FIG. 3, it converts a regular suit into a tuxedo very quickly. On the back face 722, a backing material can be used to support the front face 721 that is made out of silk or silk like materials, and therefore giving the lapel-cover 621 hardness and stiffness. The backing material can be made out of cotton or synthetic materials.

As the lapel-cover 601 of FIG. 7 is turned completely, now in FIG. 8, the fold lines 805 and 807 are shown. The fold lines 805 and 807 are meant to intimate couple the natural fold line of a lapel and merge into a single folding point 806, which matches the merging point in the suit shown previously in FIG. 1. The lapel-cover 601 of FIG. 8 shows that laminate cover further comprises a plurality of fold flaps 802, 803 and 804 respectively. In at least one embodiment of this invention, the lapel-cover 601 is shaped to be placed over the suit's lapel, at the suit's gorge line, and ends at suit folding point, thus merging point of a suit fold line (not shown).

FIG. 9 shows the lapel-cover 601 of FIG. 8 is turned completely so that the front face 921 can be shown. Superimposing the fold lines of FIG. 8, fold line 907, and fold line 905 can be shown as they merge into a single folding point 906.

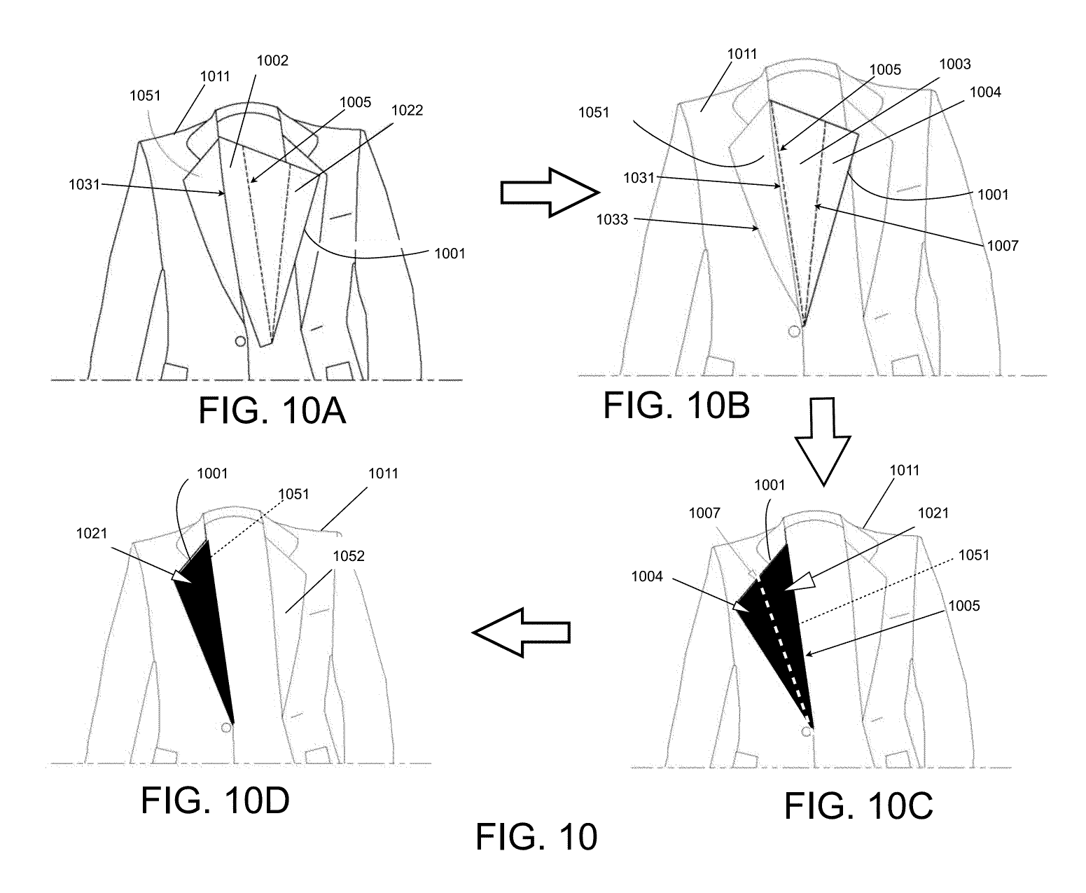

Sequence of FIGS. 10A-D, are a series of frontal graphical views that depict the method how a suit 1011 is transformed into a tuxedo look-alike using the lapel-cover 1001. The sequence of steps begins with FIG. 10-A, where the back face 1022 is inserted around the suit's lapel body 1051, with the fold line 1005 aligned against the natural fold line 1031 of the suit's lapel 1051. The sequence continues with FIG. 10-B, here, the next fold line 1007 is aimed to match with the suit's lapel edge 1033. Also, the first fold flap 1002 is fixedly attached against the inside of suit 1011. As the lapel-cover 1001 is folded over the suit's lapel 1051, the second fold flap 1003 is fixedly attached against the front of the suit's lapel 1051. Notice that the third fold flap 1004 has not been folded at this point.

On FIG. 10-C, the front face 1021 of lapel-cover 1001 is shown and the fold line 1007 and fold line 1005 matches the lapel edges of lapel 1051 (now hidden) of suit 1011. The third fold flap 1004 is ready to be folded and fixed against the back of the suit's lapel 1051. Now, in FIG. 10-D, the final depiction in the series A-C shows how the front face 1021 is now at the front of the suit's lapel 1051 (now hidden). If the sequence of steps of FIGS. 10A-C is repeated for the suit's left lapel 1052, and the suit 1011 will mimic the look of a tuxedo.

It is envisioned that the lapel cover such as the one in FIG. 10 include a single fold flap such as 1004 that wraps around a lapel, this would work in a similar way, for the same purpose, and achieve the same result.

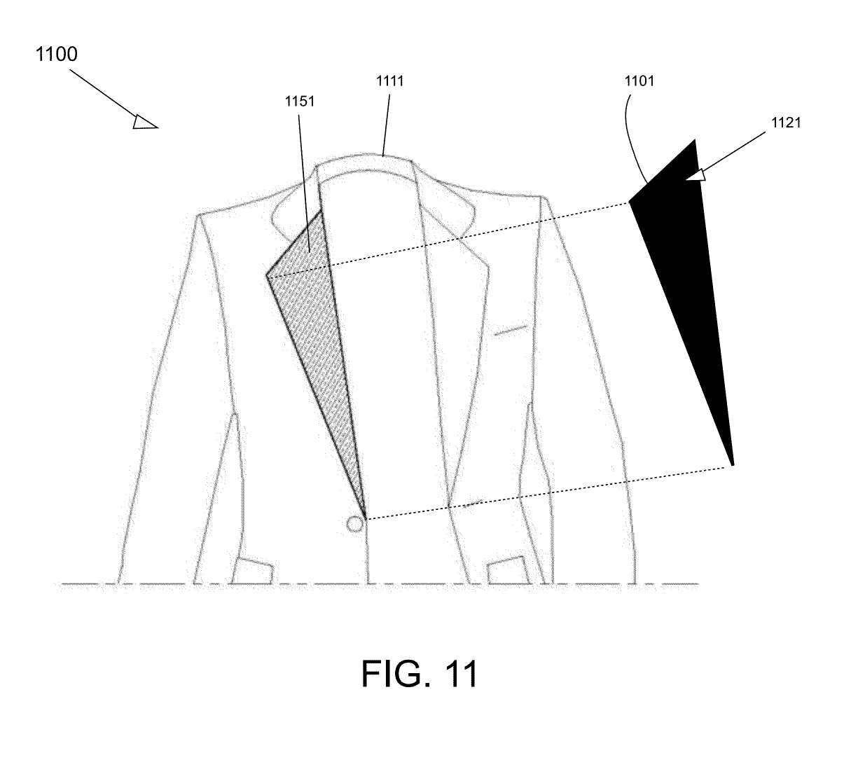

FIG. 11 is a frontal graphical depiction of an alternative embodiment of the invention, and it envisions that second fold flap (shown previously in FIG. 10A-D) can be used by itself to cover the suit's lapel 1151. Here, the triangle shaped lapel-cover 1101 is demountably fixed on top of the suit's lapel 1151 surface in order to give a regular suit a tuxedo look. The illusion is created as the lapel-cover 1101 includes a front face 1121 surface that is made out of “shiny” silk or silk like materials to emulate the look of a tuxedo lapel. Here, the lapel-cover 1101 includes a back face 1122, usually made of a more rigid material, and include a removable fixative or glue. The back face (not shown) with the fixative is mated against the front surface 1151 of the suit's lapel.

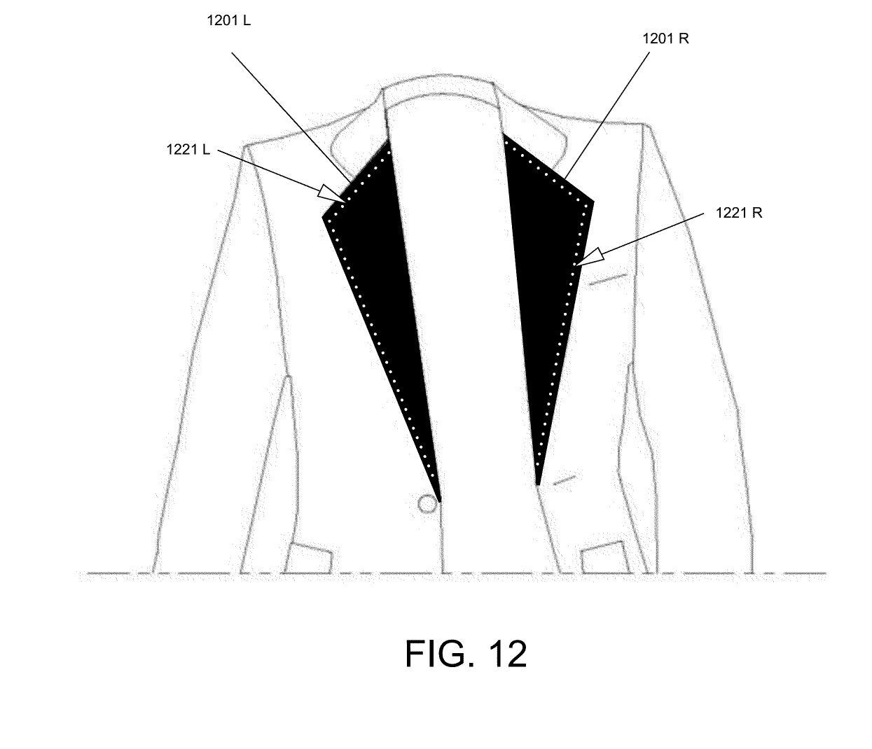

Now in FIG. 12, a graphical frontal detail depiction of a tuxedo look-alike using two lapel-covers 1201L and 1201R for both left side and right side of the suit. In order to increase the credibility of the lapel-cover 1201 (L and R), a stitched marking 1221 (L and R) is done to the lapel-cover edge. This stitched marking 1221 (L and R) is done by using a thread, and is usually of a different color than the lapel-covers 1201 (L and R). It is envisioned that this stitched marking 1221 (L and R) could be any type of color as long as it differentiates itself from the lapel-cover 1201 (L and R) color. By using the thread as color differentiator, it gives the impression that the lapel-cover 1201 (L and R) is sown right into the underlying suit.

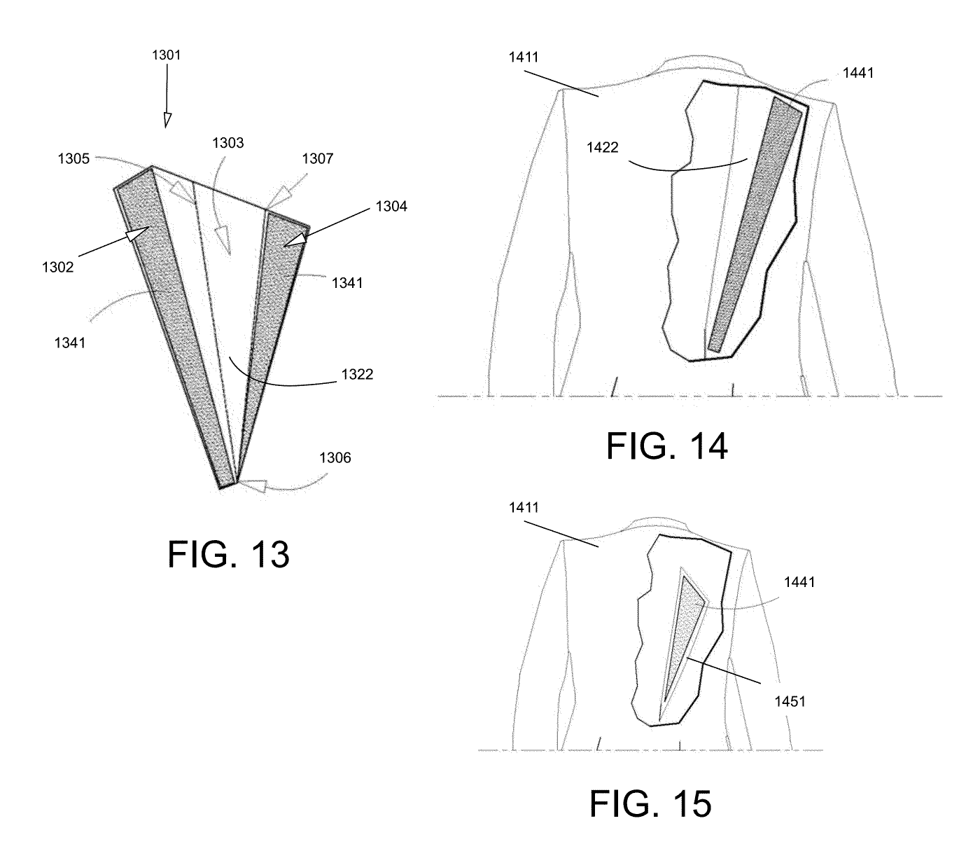

FIG. 13 shows a graphical frontal view of an embodiment of the invention, wherein; the lapel-cover 1301 tuxedo converter includes a front face (not shown), a back face 1322 and at least one fold line such as 1305 and 1307. The embodiment includes a way of attaching the lapel-cover 1301 to the lapel body of a suit by using at least one fixative 1341 in the form of double sided adhesive. By temporary affixing of the lapel fold flaps 1302, 1203 and 1304 over the lapel body, the fold lines 1307 and 1105, are intended to intimate couples to a suit's lapel edges. Here, the fold lines 1305 and 1307 are drawn along the length of the lapel-cover 1301 and merge to a single folding point 1206. The tuxedo converter lapel-cover 1301 is intended to be removable and/or interchangeable.

FIGS. 14-15 shows graphical cutouts and detailed views of the back of a suit 1411 with a cutout to show the inside of the suit. Here in FIG. 14, it shows the details of how the fixative 1441 is temporarily affixed on the inside of the suit's inner side 1422. Similarly to FIG. 14, in FIG. 15, it details how the fixative 1441 is temporarily affixed on the inside of the suit's lapel 1451.

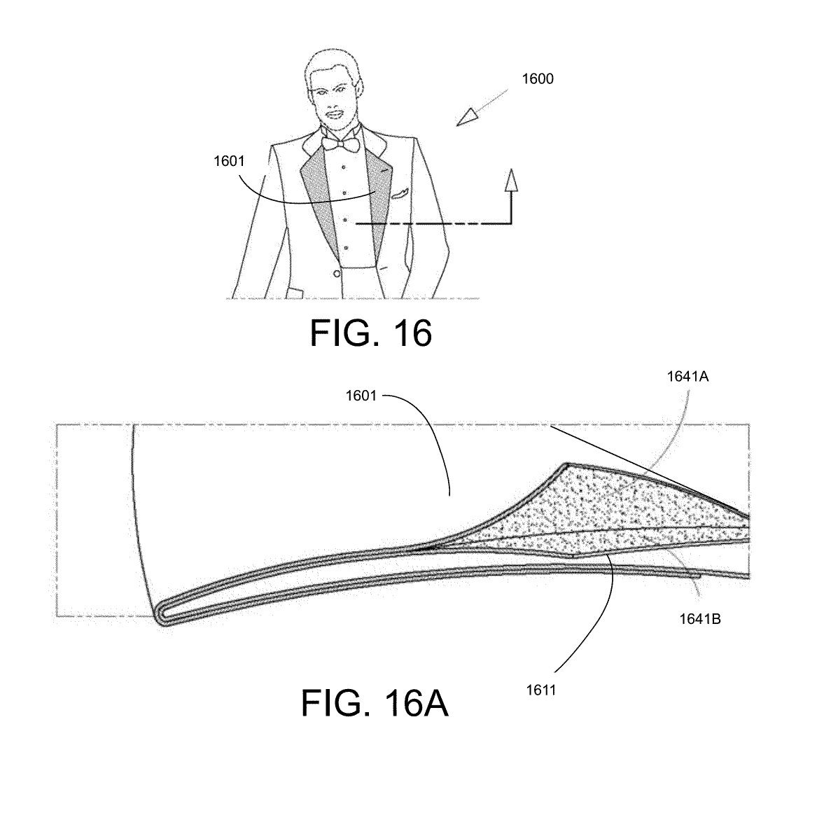

FIG. 16 is a frontal graphical depiction of the tuxedo converter 1600 as two lapel-covers 1601 have been temporarily placed on a suit transforming it into a tuxedo. FIG. 16A is a detailed cross-section of the suit's left lapel with lapel-cover 1401 from FIG. 16. As seen in FIG. 16A, the lapel-cover 1601 uses at least one fixative 1641A-B on that is demountably attached around to the front and back face of the lapel 1611 body. One of the purposes of using at least one fixative 1641A-B is to make the lapel-cover 1601 removable and interchangeable. In order to prevent shifting during use, another purposes of using a fixative 1641, is to give rigidity and stability to the lapel-cover 1601.

In one embodiment of the invention, the fixative 1511 is selected from the group consisting of; phenol-formaldehyde resins adhesives, polychloroprene, epoxy resin adhesives, cyanoacrylate adhesives, silicone adhesives, anaerobic adhesives, microstructured adhesives, polyimide adhesives, polyurethane adhesives, nylon polymer adhesives and any combination thereof. At least one of the methods of manufacturing includes spraying the fixative 1511 on to the fabric of the laminate cover 1601.

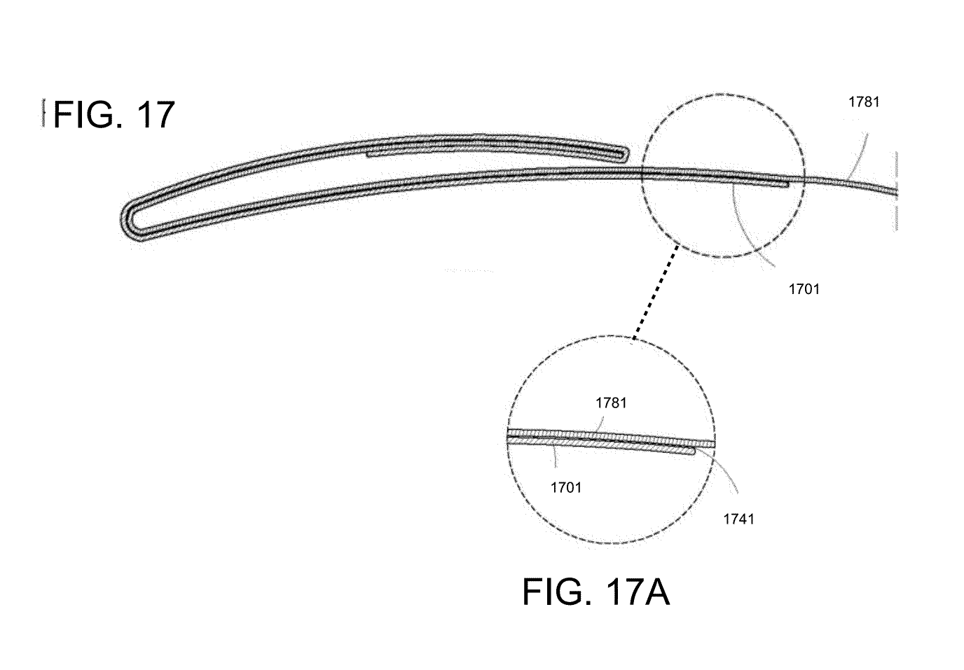

FIG. 17, is a cross-sectional graphical depiction of a suit jacket's front breast 1781 and the lapel-cover 1701 closely affixing to the back of suit jacket's front breast 1781. As shown in the detailed cross-sectional view in FIG. 17A it is intended that affixation be an intimate one. Here, the fixative 1741 is in intimate contact with both surfaces. In this particular embodiment, the lapel-cover 1701 back face was coated with a two-part silicone solution from DOW CORNING CORP, and dried at 150 degrees for two hours. The silicon mixture dried but retained the “stickiness” for the necessary temporary affixation to the suit lapel. The silicone solution made it easy to be removed from the suit lapel and if properly covered and stored it may be reused many times. FIG. 17A is a close-up of FIG. 17 wherein it the intimate contact of the silicone with the two surfaces can be shown. Another advantage of using a fixative such as silicone is that it contours it self to the lapel body very tightly without creating “bubbles” or wrinkles that could be seen and destroy the look.

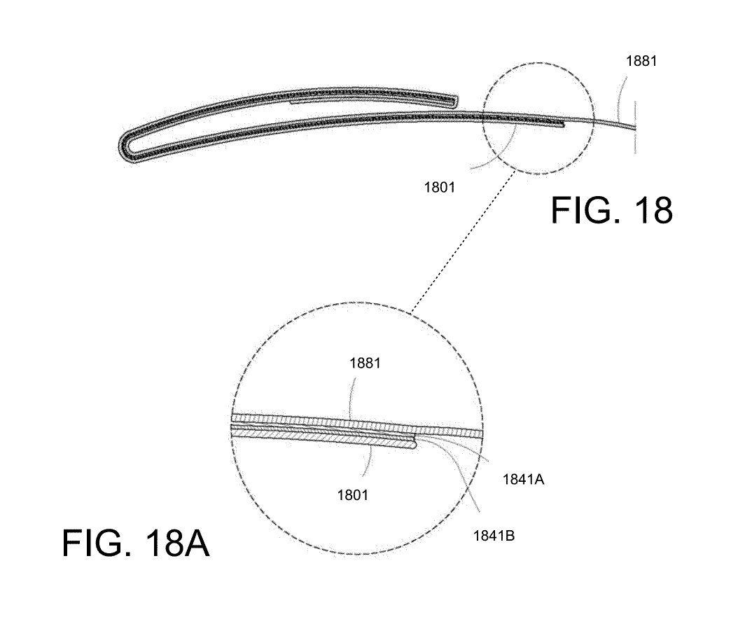

Similarly, now in FIG. 18 another cross-section a suit jacket's front breast 1781. Here a two-part approach to use fixative 1841 A-B was used. The first part 1841 by it self does not create a tacky surface, but as it chemically interacts with 1841B the lapel-cover 1801 will stick. As explained before any combinations of fixative such as glue with many chemical compositions could created the “tackiness or stickiness” needed could function in the same way to accomplish the same result. It is envisioned that at least one feature of this invention is that can be re-used several times by using the tackiness properties of the fixative 1841.

The method of manufacture of the lapel-cover 1801, comprised the following steps; the front face was made of high quality organic colored silk cloth imported from China, this roll of silk was rolled together with a tight mesh like cotton cloth which will comprise the back face of the lapel-cover 1801. The mixed silicone was then casted over the back face, at high speed, making the thickness of the silicone approximate 10 mils. The roll of silk and cotton with the silicone coating was then passed trough and oven at 150 degrees to be dried and a MYLAR plastic sheet was placed over the silicone to be rolled back again. The shape of the lapel-cover 1801 was stamped and cut with an industrial cutting machine that had the shape of the suit lapel.

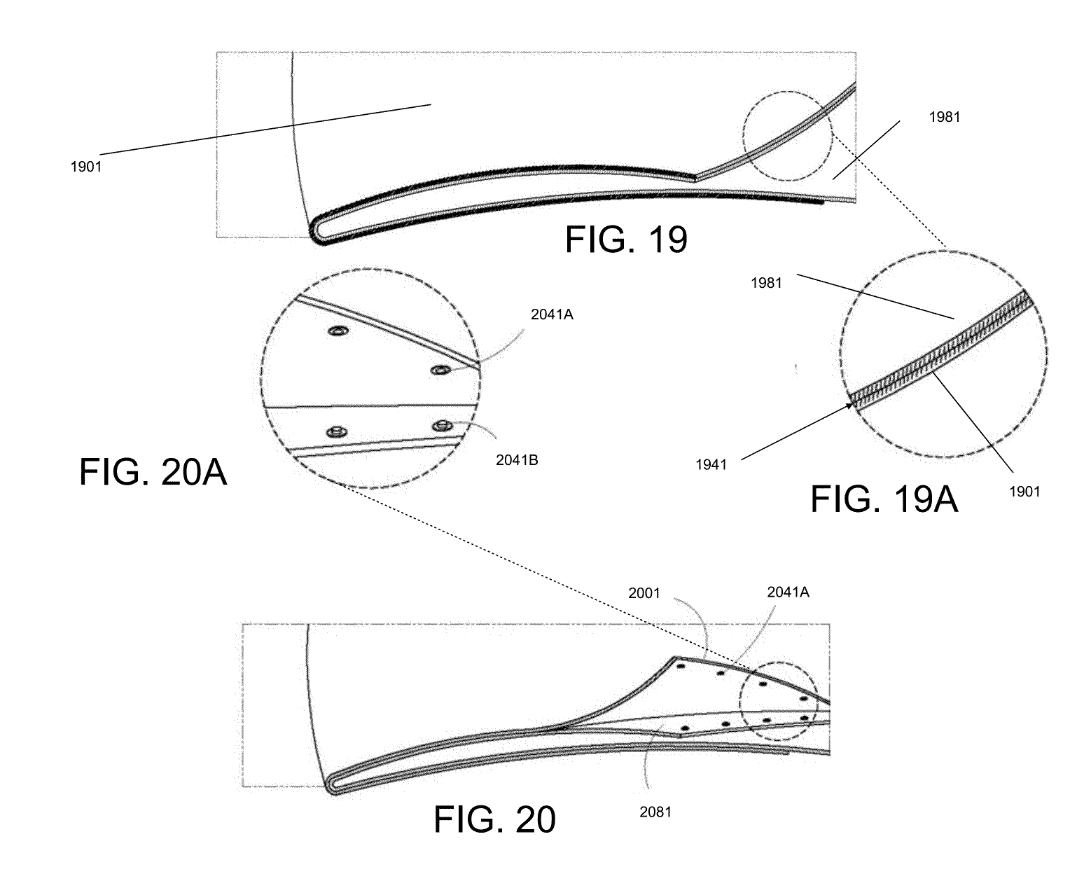

FIGS. 19-20 are cross sectional graphical depictions of lapels 1981, 2081 with mechanical fasteners, yet another embodiment of the invention. FIGS. 19A-20A, are close-up graphical depictions of a lapels 1981, 2081 with mechanical fasteners. In these embodiments, the tuxedo converter may use fixatives that are magnetic or mechanical, these include: double sided tape, adhesives, magnets (both temporary and permanent), buttons, snap buttons, zippers, VELCRO (hook and loop fastener) or any combination thereof.

As an example of mechanical fixatives, FIG. 19 and close-up FIG. 19A, depicts a magnetic fixative wherein the two surfaces are in intimate contact. This fixative solution was made using permanent magnet particles Nd—B—Fe powder from READE CORP suspended in an epoxy binder solution. The particles where sprayed lightly to both the suit lapel 1981 and the backside of the lapel-cover 1901. The binder solution was the air-dried and due to the particle attraction an intimate contact was achieved.

As another example of mechanical fasteners, and to intimate couple the lapel 1981 and the lapel-cover 1901, is accomplished using a VELCRO type hook that is attached to the suit's lapel 1981 using an epoxy resin glue. On the surface of the lapel-cover 1901, a VELCRO type loop is attached to using epoxy resin glue, and both surfaces are mated as shown in FIG. 19A.

In a final embodiment of the invention, FIG. 20 and close-up 20A, are graphical depictions of a cross-section of a lapel with a mechanical fastener. Here, the snap buttons 2041B where placed both on the lapel 2081 and 2041A on the lapel-cover 2001. Once snapped together, the laminate cover 2001 and the lapel 2081 will make intimate contact with each other. Again, the mechanical aspect of the snap buttons 2041A-B allows for the temporary nature of this tuxedo converter system and its ultimate goal of converting a regular suit to look like a tuxedo quickly and inexpensively.

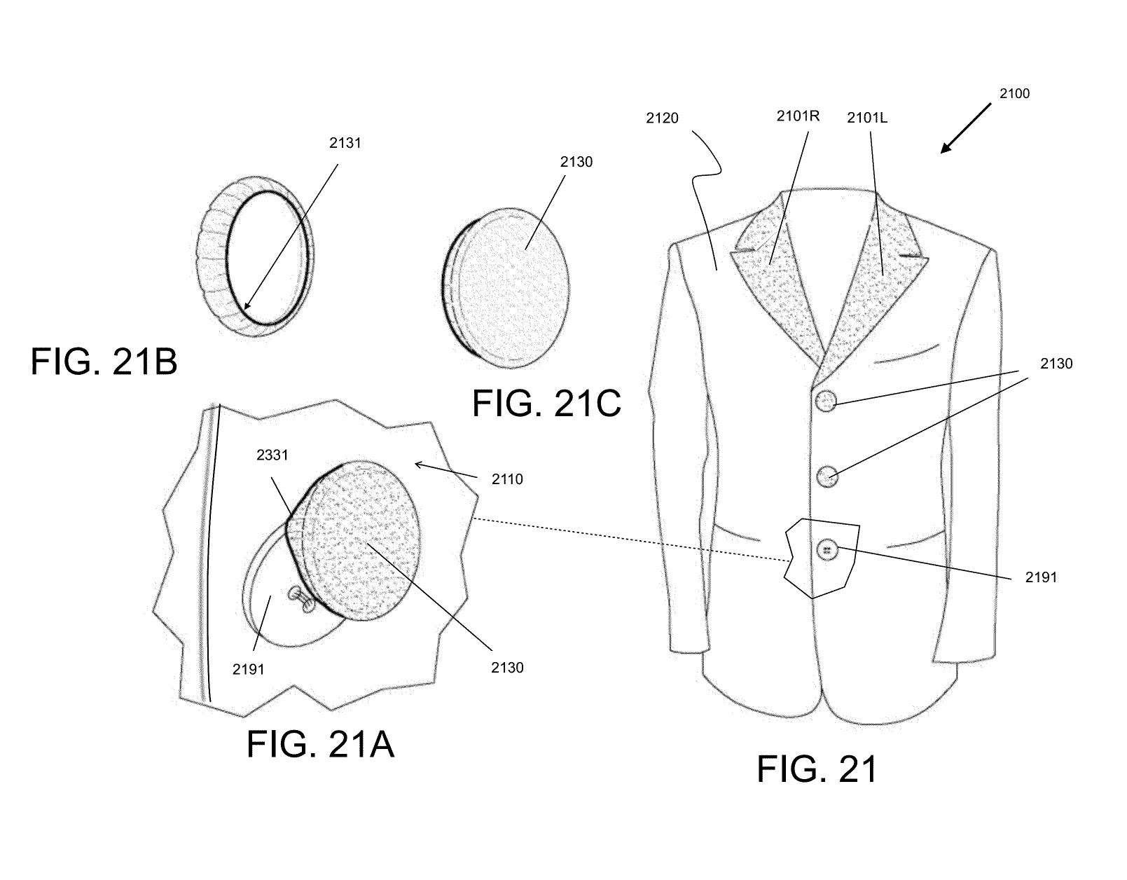

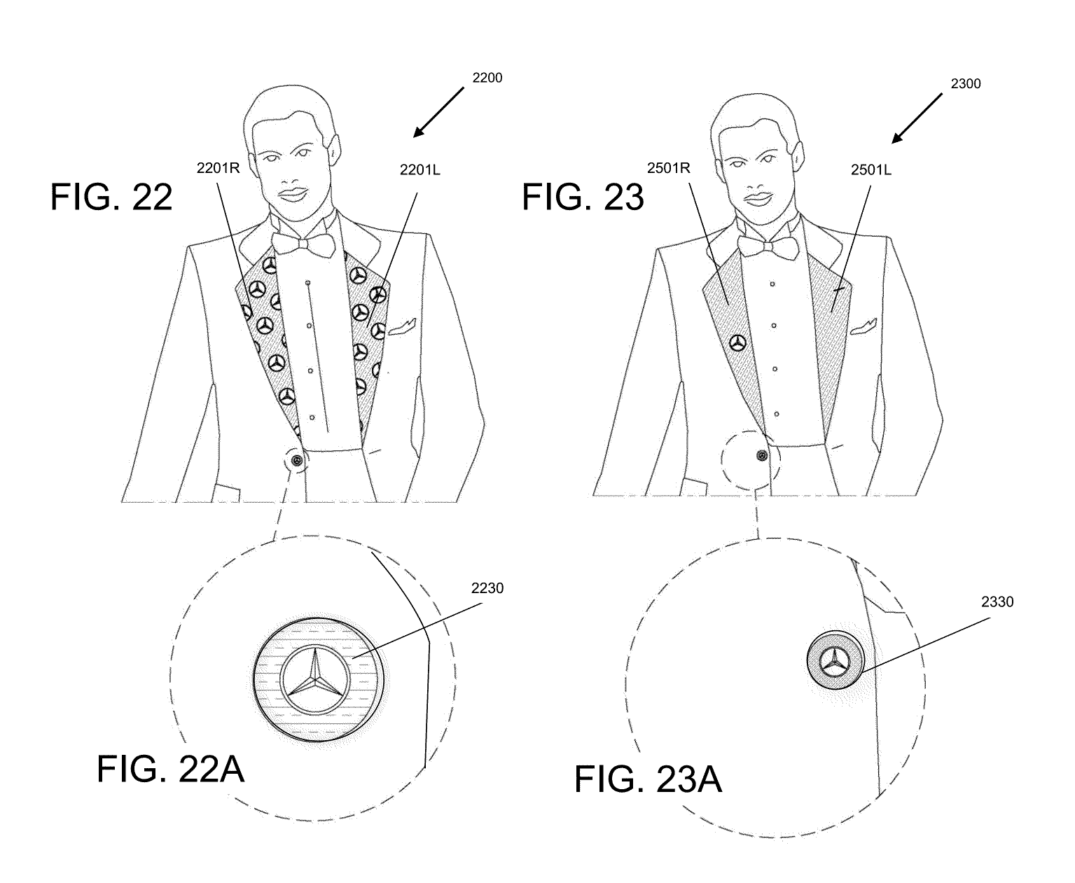

FIG. 21 is frontal view, graphical depictions of one embodiment the tuxedo converter 2300, and FIGS. 21A-C are close-up views of FIG. 21. The tuxedo converter 2100 includes: a set of lapel-covers, namely, a left lapel-cover 2101L a right lapel-cover 2101R, and a plurality of button-converters 2130. Close-up view FIG. 21A shows how the button-converter 2120 wraps around the body of the suit's button 2191 using an elastic band 2131 to hold it together. The elastic band 2131 can be better shown in FIG. 21B, here, the band encircles the edge of the back of button-converter 2130. FIG. 21C shows that the button converter 2130 looks seemingly like a tuxedo button. The button-converter 2130 introduces a novel way to transform a regular suit button into a fancy tuxedo button look-alike effortlessly.

As shown in FIG. 21, one embodiment of the tuxedo converter 2100, it is intended that both the button-converter 2191 and the lapel-covers 2101L-R are made of the same type of fabric to match each other. Some non-limiting examples include fabrics such as velvet, leather, swede, silk, polyester, and cotton. It is also envisioned for the fabric to be covered with glow in the dark neon paint artwork made by artists.

FIG. 22 and FIG. 23 are frontal graphical depictions of another embodiment of the tuxedo converters 2200 and 2300 could be sold as a kit. In this embodiment, the tuxedo converters 2200 and 2200 are intended to serve as marketing tools for businesses and non-profits. For example, it is intended for the lapel-covers 2201L-R to be on top alumni jackets, and buttons covered with button-converters 2230, showing the colors and logos of an alma mater to be used at Universities at reunions and special events. Similarly, in another non-limiting marketing use of the tuxedo converter 23, shown in FIG. 23 and close-up FIG. 23A, is having licensed logos for companies such as MERCEDES to be used on lapel-covers 2301L-R and button-converters 2330 for promotional purposes. Other marketing examples include: product promotions, charity events, and non-profits such as the cancer society.

In another embodiment of the tuxedo converter 2300, the lapel-covers 2301L-R are manufactured not to be reusable, i.e. disposable, and hence made non-expensive materials. Disposable uses include, to cheaply standardizing a workforce, for example, a restaurant staff, can wear restaurant logo on the lapel-covers 2301L-R and button-converters 2330, making all its waiters uniform. Other non-limiting uses include: sports teams, security in night clubs with glow in the dark lapels, political parties campaigns, company logos for trade shows, name tags, branding, all marketing related, costumes, and more.

The marketing aspect of the tuxedo converter 2300 is accomplished by the following method: 1) a person uploads its logos using a computer to a website on the world wide web; 2) the user chooses a color and type of fabric; 3) the user places an order and gives a quantity; 4) the laminate covers and button converters are manufactured for the user; 4) the order is shipped and delivered via mail to the user.

A tuxedo converter has been disclosed in several embodiments. Within the laminate covers and button converters have also been disclosed. The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are within the meaning and range of equivalents of the disclosed embodiments, based on the teaching and guidance presented herein. The phraseology or terminology is for description and not of limitation, such that the terminology or phraseology of the present specification is interpreted by the skilled artisan in light of the teachings and guidance. The breadth and scope of the present invention should not be limited by the above-described exemplary embodiments, but should be defined only under the following claims and their equivalents.

It is to be appreciated that the Detailed Description section, and not the Abstract section, is intended to be used to interpret the claims. The Abstract section may set forth one or more but not all exemplary embodiments of the present invention as contemplated by the inventor, and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. The breadth and scope of the present invention should not be limited by any of the above-described exemplary embodiments, but should be defined only in accordance with the following claims and their equivalents.

What we claim is:

1. A tuxedo converter, comprising:
at least one lapel-cover, the lapel-cover further comprising: a front face and a back face operable to demountably dispose around a lapel body.

2. The tuxedo converter of claim 1, further comprising:
at least one button converter.

3. The tuxedo converter of claim 1, wherein:
the at least one lapel-cover further comprises at least one fold line operable to couple a lapel fold line.

4. The tuxedo converter of claim 1, wherein:
the at least one lapel-cover further comprises at least one fold flap.

5. The tuxedo converter of claim 1, wherein:
the at least one fixative is attached to the back face of the at least one lapel-cover.

6. The tuxedo converter of claim 1, wherein:
the at least one lapel-cover further includes a interior fold-line, a exterior fold-line, a gorge line and a folding point.

7. The tuxedo converter of claim 1, wherein:
the at least one lapel-cover is interchangeable.

8. The tuxedo converter of claim 1, further comprising:
a fixative.

9. The tuxedo converter of claim 8, wherein:
the fixative is chemical, mechanical and any combination of both.

10. A method to convert as suit jacket into a tuxedo look-alike, the method comprising the step of:
using at least one lapel-cover operable to demountably dispose around a lapel body using a fixative.

11. The method of claim 10, further comprising the step of:
using at least one button-converter operable to demountably dispose around a button using an elastic band.

12. The method of claim 10, wherein:
the at least one lapel-cover further comprises at least one fold line operable to couple a lapel fold line.

13. The method of claim 10, wherein:
the at least one lapel-cover further comprises at least one fold flap.

14. The method of claim 10, wherein:
the fixative is attached to the back face of the at least one lapel-cover.

15. The method of claim 10, wherein:
the at least one lapel-cover further comprises a interior fold-line, a exterior fold-line, a gorge line, and a folding point.

16. The method of claim 10, wherein:
the at least one lapel-cover is interchangeable.

17. The method of claim 10, wherein:
the fixative is chemical, mechanical and any combination of both.

18. A method to market business using a personalized tuxedo converter kit comprising the steps of:
uploading a logos using a computer to a website on the world wide web;
choosing a color and type of fabric for the personalized tuxedo converter kit;
choosing a quantity;
paying for the personalized tuxedo converter kit;
manufacturing the personalized tuxedo converter kit, the personalized tuxedo converter kit comprising:
at least one lapel-cover operable to demountably dispose around a lapel body using a fixative; and at least one button-converter operable to demountably dispose around a button using an elastic band; and
delivering the personalized tuxedo converter kit via mail.

19. The method of claim 18, wherein:
the at least one lapel-cover further comprises at least one fold line operable to couple a lapel fold line.

20. The method of claim 18, wherein:
the at least one fixative is attached to the back face of the at least one lapel-cover.
